(19) United States
(12) Patent Application Publication
(10) Pub. No.: US 2010/0166404 A1
(43) Pub. Date: Jul. 1, 2010

(54) Device and Method Using a Touch-Detecting Surface

(76) Inventor: Michael J. Lombardi, Lake Zurich, IL (US)

Correspondence Address: Whyte Hirschboeck Dudek S.C./Motorola, Intellectual Property Department, 555 East Wells Street, Suite 1900, Milwaukee, WI, 53202, US

(21) Appl. No.: 12/347,022

(22) Filed: Dec. 31, 2008

(51) Int. Cl. G03B 13/32; G03B 17/00

(52) U.S. Cl. 396/89; 396/263

(57) ABSTRACT

An image capture device and related method are described. The image capture device includes one or more touch-detecting surfaces for detecting both a first and a second touch. The touch-detecting surfaces can be a touch screen, a touch pad, or a combination of the two. A processor in communication with the one or more touch detecting surfaces controls the execution of an auto-focus operation in response to the first touch and an image capture operation in response to the second touch.

### FIELD OF THE INVENTION

The present invention relates to image capture devices and, more particularly, to image capture devices having touch-detecting surfaces.

### BACKGROUND OF THE INVENTION

Image capture devices, such as film and digital cameras, are in widespread use all over the world for capturing still and/or video images. A camera allows light from one or more objects within a field of view to selectively enter the camera through a photographic lens to be recorded on film or by an electronic image sensor.

Cameras can be a fixed focus type or an adjustable focus type. For a fixed focus camera, objects greater than a given distance (typically around eight feet) from the camera are in focus and will be reproduced clearly in the captured images. An adjustable focus camera requires camera adjustments to be made, such as changing a distance between the lens and the electronic image sensor (or film), in order to capture sharp images.

A variety of manual and automatic techniques have been employed for accurately focusing a camera. A manual technique to achieve proper focus requires a user to manually rotate the lens, which changes the distance between the lens and the electronic image sensor (or film). Automatic focus techniques automatically make these camera adjustments, with the amount of the adjustment calculated by the camera using a selected object within a focus area which is typically centered in the field of view. The adjustments can be calculated based on sharpness image processing calculations of acquired image data, or based on an estimation of distance between the camera and the selected object using, for example, an infrared reflective measurement technique.

Many conventional cameras use a two-position mechanical switch to activate an auto-focus operation and also an image capture operation. Typically, the switch is pressed to a first position (e.g., half-way through) for activating the auto-focus operation, and then the switch is pressed to a second position (e.g., fully pressed) for activating the image capture operation.

Although such two-position switches are adequate in most regards for focusing and capturing images, these switches also often have certain disadvantages associated with them. For example, with repeated use, conventional two-position switches tend to become defective, less reliable, and prone to malfunction, affecting one or both of the focus and image capture operations. In addition, conventional two-position switches are permanent fixtures on the camera and occupy valuable surface area. Further, cameras with these switches are more expensive to manufacture, which in turn increases the overall cost of the camera.

Given the limitations associated with these conventional two-position switches, there is an opportunity to develop an alternate mechanism for focusing a camera and capturing an image.

### BRIEF DESCRIPTION OF THE DRAWINGS

FIGS. 1 and 2 show front and rear perspective views, respectively, of an exemplary digital camera having a touch-detecting surface, in accordance with some embodiments of the present invention;

FIG. 3 is a block diagram showing exemplary internal components of the digital camera of FIGS. 1 and 2, in accordance with some embodiments of the present invention;

FIGS. 4-7 show in schematic form several exemplary arrangements of one or more touch-detecting surfaces on respective digital cameras, in accordance with some embodiments of the present invention;

FIG. 8 is a flowchart showing exemplary steps of capturing an image using one or more touch-detecting surfaces of the previous digital cameras, in accordance with some embodiments of the present invention;

FIGS. 9-11 are timing diagrams illustrating various timing scenarios of first and second touches.

### DETAILED DESCRIPTION OF THE PREFERRED EMBODIMENT

The invention relates to a device and method using one or more touch-detecting surfaces for initiating auto-focus and image capture operations. The touch-detecting surfaces can take the form of a touch screen, a touch pad, or a combination of the two. The touch-detecting surfaces can be any of a variety of known touch-detecting technologies such as a resistive technology, a capacitive technology, an optical technology, or others, and can be capable of detecting a single touch or multiple touches. Applying a first touch to one of the touch-detecting surfaces initiates an auto-focus operation, and applying a second touch on the same or a different touch-detecting surface initiates an image capture operation. These touches can be separate in time or overlapping in time, depending on the type or types of the touch-detecting surfaces. The one or more touch-detecting surfaces are in communication with a processor of the camera, which controls the execution of the auto-focus operation and the image capture operation in response to the detection of the applied first and second touches.

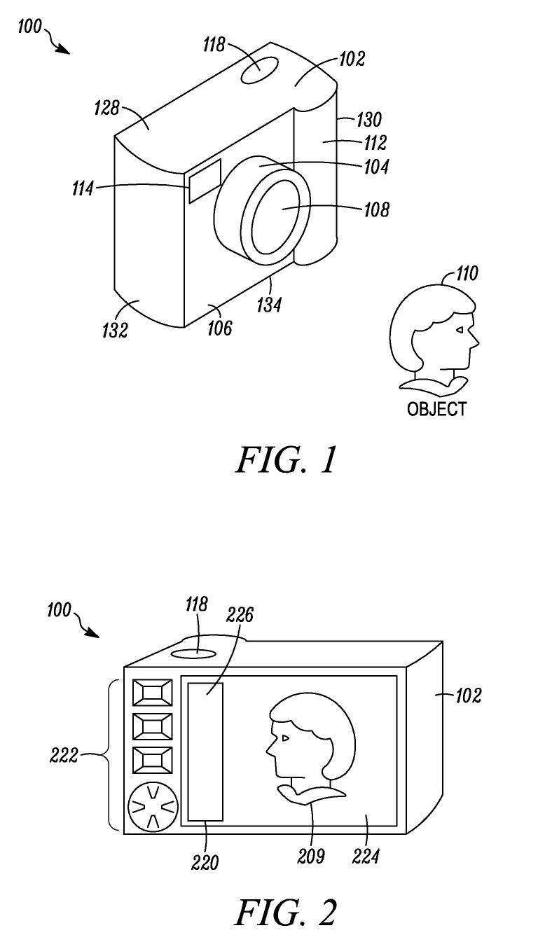

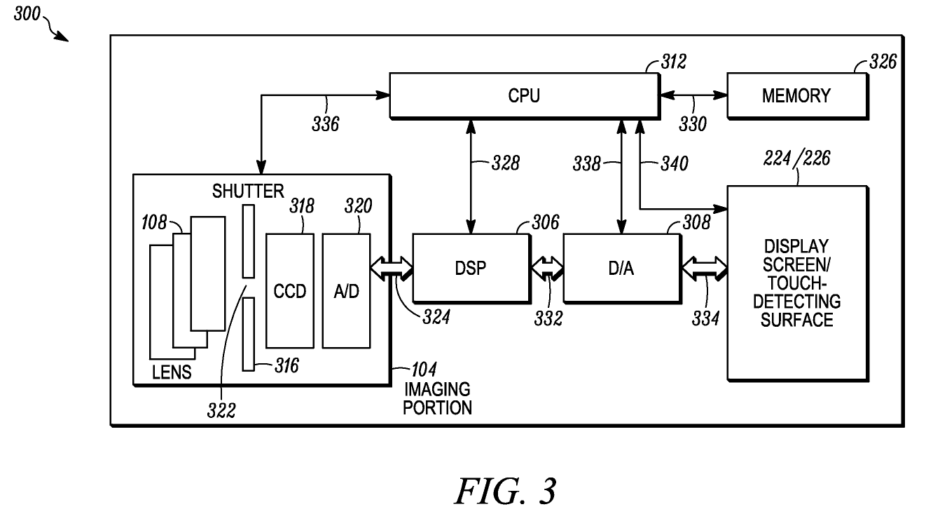

Referring to FIGS. 1 and 2, shown are front and rear perspective views, respectively, of an exemplary digital camera 100 in accordance with at least some embodiments of the present invention. As shown, the digital camera 100 includes a camera body 102 having an imaging portion 104. The imaging portion 104, which is described in greater detail with respect to FIG. 3, includes, among other components, an objective lens 108 on a front side 106 of the camera body 102, through which light enters the camera for capturing an image 209 (shown in FIG. 2) of an object 110. In addition to the imaging portion 104, the front side 106 includes an elongated and curved grip portion 112, attached or otherwise integrally formed with the camera body 102 for providing a comfortable and firm grip of the digital camera 100 to a user during operation and handling.

The front side 106 further includes a photographic flash 114 for illuminating the object 110 during conditions of low light to capture a good image. Typically, the photographic flash 114 is connected at least indirectly to the imaging portion 104 such that the operation of the imaging portion is synchronized with the operation of the photographic flash during image capture. Further, the digital camera 100 includes a power switch 118 for powering on and off the digital camera.

A rear side 220 of the digital camera 100 includes a plurality of operative buttons 222, a display screen 224, which can be a Liquid Crystal Display (LCD), and a touch-detecting surface 226. The plurality of operative buttons 222 can include any number of buttons for performing a variety of operations, including, for example, a delete button for deleting images, a play button for viewing prior captured images, a menu button for changing user settings of the digital camera 100, a flash button for activating/de-activating the photographic flash 114, as well as buttons to switch between manual and automatic modes of operation.

With respect to the display screen 224, it can be utilized as a view finder to aid in the positioning of the object 110 within the camera's field of view, as well as for displaying captured images such as image 209. The touch-detecting surface 226 can be a light permeable panel or other technology which is added to create a touch screen on all or a portion of the display screen 224. Although the touch-detecting surface 226 is shown in FIG. 2 as overlapping only a portion of the display screen 224, in many implementations the touch-detecting surface 226 will completely overlap the display screen 224. In a completely-overlapping implementation, the combined touch-detecting surface and display screen is generally called a touch screen.

As explained below, applying two touches on the touch-detecting surface 226 initiates both an auto-focus operation and an image capture operation. The touch-detecting surface can also be used to perform other functions or implement various camera settings, in addition to, or in lieu of, those performed by the plurality of operative buttons 222. The touch-detecting surface 226 can take other forms, such as multiple touch screens, one or more touch pads which need not be light permeable, or the combination of a touch screen and a touch pad. The touch-detecting surface 226 can be situated anywhere on the body of the camera. In addition to, or as an alternate to, placing the touch-detecting surface 226 on the rear side 220 of the camera body 102, a touch-detecting surface can be placed on the front side 106, a top side 128, a right side 130, a left side 132, and/or a bottom side 134.

Depending on type, the touch-detecting surface 226 can measure either a single touch at a time by a user or multiple touches that overlap in time. The touch signal input can be provided by way of touching the touch-detecting surface 226 by various means, including for example using one or more hands, fingers, thumbs, fingernails, or passive stylus devices. In some embodiments, the touch-detecting surface 226 can be activated by way of other types of actions, such as by swiping, pinching, and applying pressure, which actions are all considered touches. However, the touch-detecting surface 226 need not be capable of distinguishing between different pressures or forces of touches.

Turning now to FIG. 3, a block diagram 300 is shown which includes various exemplary internal components of the digital camera 100, in accordance with at least some embodiments of the present invention. Components necessary for the understanding of operation of the camera 100 include the imaging portion 104, a digital signal processing (DSP) component 306, a digital-to-analog (D/A) converter 308, and the touch-detecting surface 226, shown here in combination with the display screen 224. All of these components are in communication with and operate under the control of a processor such as a central processing unit (CPU) 312, which is in communication with a memory 326.

The touch-detecting surface 126 provides a signal via link 340 to the CPU 312 indicative of an applied touch. The CPU monitors output signals from the touch-detecting surface 226 and, in conjunction therewith, when a touch signal is detected, can determine a location (e.g., co-ordinates) of the applied touch on the touch-detecting surface 226. The CPU 312 can then generate one or more instructions in the form of output signals to camera components for performing one or more operations corresponding to the area, or areas, being touched.

More specifically, the imaging portion 104 includes the objective lens 108, a shutter 316, an image sensor 318, and an analog-to-digital (A/D) converter 320 connected together in operational association. The camera 100 also includes an auto-focusing function which can be achieved in a variety of ways, such as by controlling the distance between the lens 108 and the image sensor 318 using an actuator such as a motor (not shown) under the control of the CPU 312. The opening and closing of the shutter 316 to capture an image is also under the control of the CPU 312. Thus, the detection of two applied touches to one or more designated areas of one or more touch-detecting surfaces can initiate the generation of instructions to the motor for performing an auto-focus operation and to the shutter to control its opening and closing for an image capture operation. Specifically, the lens 108 gathers and focuses light from objects within the camera's field of view, which light passes through an aperture 322 of the shutter 316 when the shutter is open. This light is measured by the image sensor 318 at each of a plurality of pixels for image capture, and converted to digital signals by the A/D converter 320.

The amount of light measured by the image sensor 318 can be controlled by varying the size of the aperture 322, as well as by varying the speed of the opening and closing of the shutter 316. The photographic flash 114 can also be employed for illuminating the object to capture a good image, and the timing of the shutter 316 can be synchronized with a flash generating circuit (not shown) to generate the photographic flash. The lens 108 can be any of a number of different types of known lenses. The shutter 316 can be any of a variety of commonly employed shutters such as focal-plane shutters, leaf shutters, central shutters, and diaphragm shutters. Further, the image sensor 318 can be any of a wide variety of image sensors including, for example, a charge-coupled device (CCD) image sensor and a complementary metal oxide semiconductor (CMOS) image sensor. With a CCD device type of image sensor, light corresponding to each pixel of the captured image is converted into electrons (e.g., charge), which is then converted into digital image signals using the A/D converter 320.

The digital image signals generated by the A/D converter 320 are then provided to the DSP component 306 for processing via link 324, and can also be automatically saved in memory 326, under the control of the CPU 312, via links 328 and 330, respectively. The memory 326, where the captured image is stored, can be any of a variety of fixed, removable, or a combination of fixed and removable memories of various forms including, for example, flash memories such as SmartMedia cards, CompactFlash cards, memory sticks, as well as other high capacity memories.

After processing signals corresponding to the captured image, the DSP component 306 passes along the digital image signals to the D/A converter 308 via link 332, which converts those signals back into analog image signals. The analog image signals are then transmitted via link 334 to the display screen 224 for reproducing the captured image. Similar to the DSP component 306, the timing and operation of all the components (e.g., the objective lens 108, the shutter plate 316, the image sensor 318, and the A/D converter 320) of the imaging portion 104, as well as the D/A converter 308, the display screen 224, and the touch-detecting surface 226 is synchronized under control by the CPU 312, via links 336, 338, and 340.

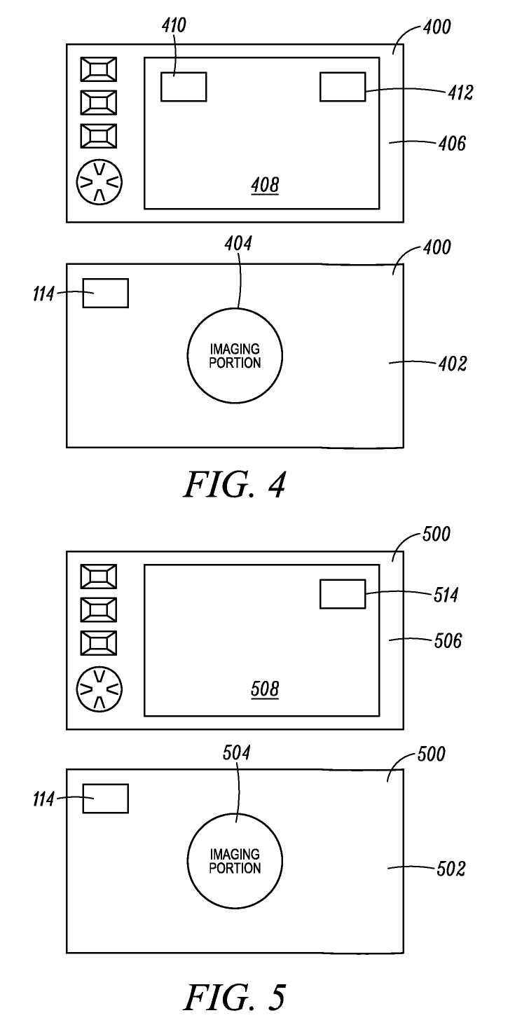

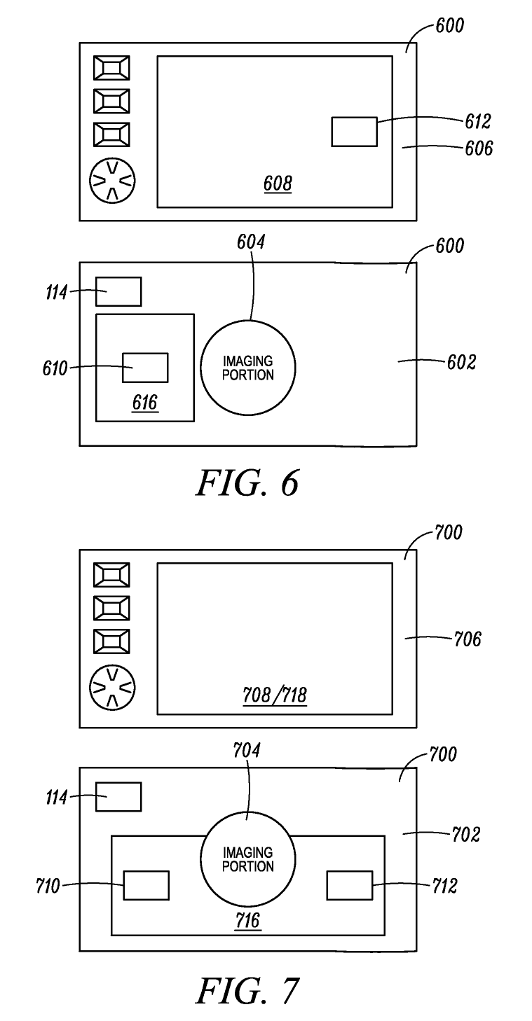

Turning now to FIGS. 4-7, shown are various exemplary arrangements of one or more touch-detecting surfaces, such as touch screens and/or touchpads, in respective cameras 400, 500, 600, 700. Specifically, each of FIGS. 4-7 shows a front side 402, 502, 602, 702 having an imaging portion 404, 504, 604, 704, as well as a rear side 406, 506, 606, 706 having a display screen with a touch-detecting surface forming the touch screen 408, 508, 608, 708. FIGS. 6 and 7 illustrate touch pads 616, 716 on the front side 302. These touch screens and touch pads can be located at other locations on the camera body as well. Although not shown, it will be understood that other components associated with digital cameras, including the components described above with respect to FIGS. 1-3 can be present in the digital cameras 400, 500, 600, 700.

Turning now to FIG. 4, the touch screen 408 can be utilized as a view finder for composing an image before capture, displaying an image after capture, as well as for detecting applied touches at two or more areas of the touch screen. The touch screen 408 generates signals indicative of applied touches which are received by the processor (e.g., the CPU 312), which generates instructions for executing an auto-focus operation and an image capture operation. To perform the focusing and the image capture operations, two different areas within the touch screen 408 are designated, such as a first area 410 designated as a focus area, and a second area 412 designated as an image capture area. If the touch screen 408 is a type that recognizes only a single touch at a time, the user applies a first touch to the area 410 to focus the camera 400, releases the touch with the first area 410, and then applies a second touch to the second area 412 to capture the image. If the touch screen 408 is a type that recognizes multiple touches, the user applies a first touch to the first area 410 to achieve focus, and applies a second touch to the second area 412, which can be applied while still holding and maintaining contact with the first area 410.

The first area 410 and the second areas 412 are preferably situated on the touch screen 408, such as in the left and right corners, to allow an image to be displayed with minimal interference, although these areas can be situated anywhere on the touch screen 408.

Referring now to FIG. 5, the touch screen 508 has a single designated area 514, rather than two separate designated areas, for initiating both the focus and image capture operations. In this case, the touch screen need only recognize a single touch at a time (not multiple concurrent touches). A user applies a first touch to the area 514 to achieve focus, releases the first touch, and then applies a second touch to the area 514 for capturing the image. The location of the area 514 on the touch screen 508 can vary.

As shown in FIGS. 6 and 7, in contrast to the camera illustrated in FIG. 4 in which both the first and the second areas 410 and 412 were provided on the touch screen 408, in the cameras 600 and 700, at least one of those areas is instead provided on a respective touch pad 616, 716.

Specifically, as shown in FIG. 6, a first area 610 on camera 600 is provided on the touch pad 616 on the front side 602 of the camera, while a second area 612 is provided on the touch screen 608 on the rear side 606 of the digital camera. A user applies a first touch to area 610 (or area 612) to achieve focus, and applies a second touch to the other area, namely area 612 (or area 610) for image capture. In this case, because there are two separate touch-detecting surfaces, the two touches can occur sequentially or can overlap in time. As shown, the locations of areas 610, 612 facilitate a first touch to focus and a simultaneous first-and-second touch (i.e., a “pinch”) to capture an image.

Relatedly, as shown in FIG. 7, both the first and the second areas 710 and 712 are provided on touch pad 716 on the front side 702 of the digital camera 700. The rear side 706 of the digital camera 700 may include a display screen 718 that might not be a touch screen. Applying a first touch on the first area 710 (or area 712) initiates an auto-focus operation, and applying a second touch on the second area 712 (or area 710) initiates an image capture operation. The touch pad 716 can be a type capable of detecting a single touch at a time or a type capable of detecting multiple touches overlapping in time, as described above. Additionally, although the touch pad 716 has been provided on the front side 702 of the digital camera 700, one or more touch pads can be provided on other surfaces as well to support alternate first areas and second areas. For example, the first area and the second area could be placed on the left and right sides of a top surface 128 (as shown in FIG. 1) of the camera 700.

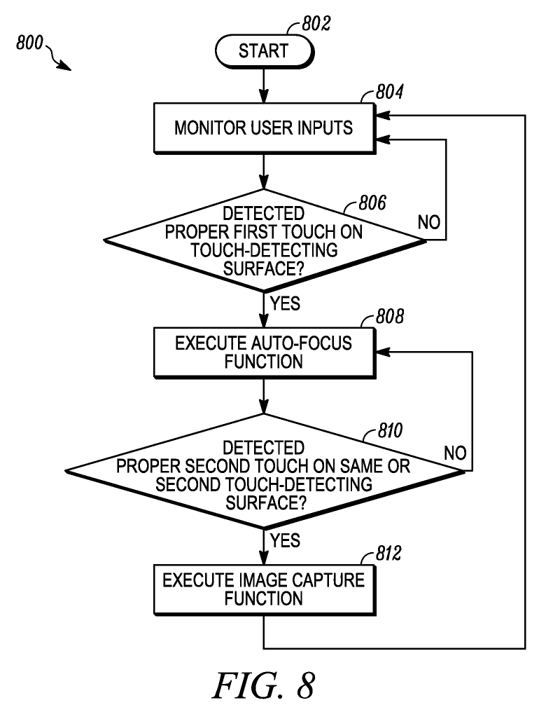

Referring now to FIG. 8, a flowchart 800 showing exemplary steps of operation of the digital cameras 100, 400, 500, 600, 700 is shown. The process starts at a step 802 when the camera is turned on for use. Next, at a step 804, the digital camera monitors user inputs.

At a step 806, the camera detects whether a proper first touch is applied to a touch detecting surface. A proper first touch occurs for example when a first touch is applied to a designated focus area on a touch-detecting surface, such as area 410 on touch screen 408 of FIG. 4, area 514 on touch screen 508 of FIG. 5, area 610 on touch pad 616 of FIG. 6, or area 710 on touch pad 716 of FIG. 7. Generally speaking, contact with the designated focus area can be maintained until the digital camera is properly focused, although the camera can detect merely a first touch of a predetermined duration.

If a proper first touch is not detected, then processing proceeds to step 804. If a proper first touch is detected, then processing proceeds to step 808. At step 808, the camera executes an auto-focus function, and processing proceeds to a step 810.

At a step 810, the camera detects whether a proper second touch is applied to the same or a different touch detecting surface. A proper second touch occurs for example when a second touch is applied to a designated capture area, which can be the same as or different than the designated focus area on the same or a different touch detecting surface, such as described above with respect to FIGS. 4-7. For example, a proper second touch can occur by an applied touch on area 412 on touch screen 408 of FIG. 4, on area 514 on touch screen 508 of FIG. 5, area 612 on touch screen 608 of FIG. 6, or area 712 on touch pad 716 of FIG. 7. The proper second touch can be a single touch of the touch-detecting surface (e.g., the touch screen and/or the touch pad) in which the image capture designated area (which in some embodiments will be the same as the designated focus area) is touched after releasing an applied first touch on the designated focus area, or alternatively, can be part of a multi-touch operation involving touching and maintaining contact with the image capture area while simultaneously maintaining contact with the focus area.

If a proper second touch is not detected, then processing proceeds to step 808. If a proper second touch is detected, then processing proceeds to step 812. At step 812, the camera executes an image capture function. Depending upon the digital camera, signals corresponding to the captured image can be automatically saved within a memory, such as the memory 326. The captured image can be displayed on the display screen 224 for viewing by the user.

If not, the camera can be turned off at a step 416 before the process ends at a step 418.

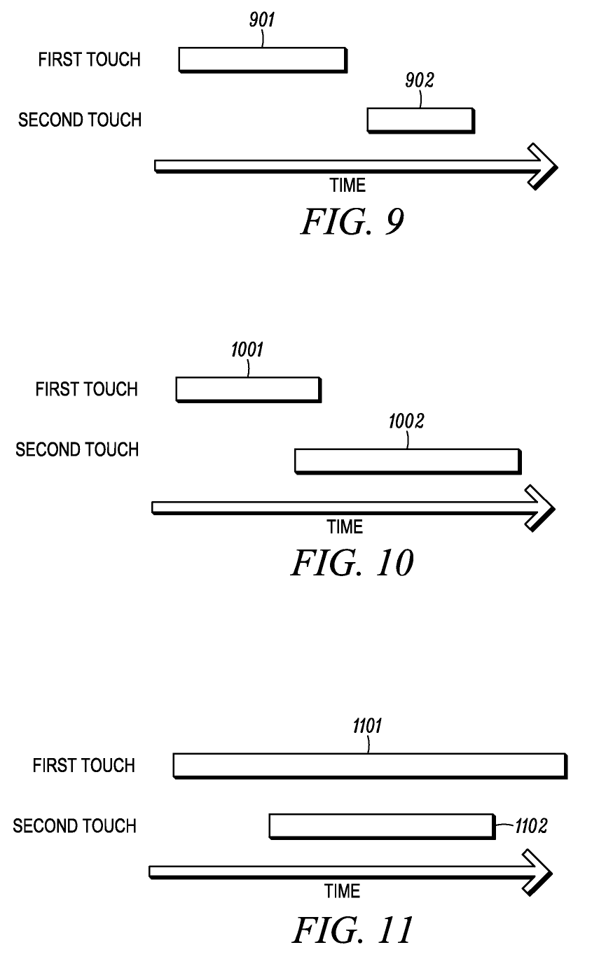

Referring to FIGS. 9-11, these timing diagrams show various scenarios of first and second touches. In particular, FIG. 9 illustrates an applied first touch 901 and an applied second touch 902 which are non-overlapping in time. FIG. 10 illustrates an applied first touch 1001 and an applied second touch 1002 which partially overlap in time. FIG. 11 illustrates an applied first touch 1101 and an applied second touch 1102, which overlap in time, with the applied first touch 1101 being applied before and after the applied second touch 1102.

By utilizing a touch-detecting surface for both focus and image capture operations, the functionality provided by a two-position switch for focus and image capture can be achieved, and the two-position switch can be eliminated, resulting in a sleeker, more reliable, and less expensive camera design.

Notwithstanding the various embodiments of auto-focus and image capture using one or more touch-detecting surfaces described above with respect to FIGS. 1A-4, several refinements, as well as additional features, are contemplated and considered within the scope of the present invention. For example, although the present invention has been explained with respect to touch pad and touch screen type of touch-detecting surfaces, other types of touch-detecting surfaces, and touch panels, can be employed.

Further, the invention is not restricted to use with a digital camera. In other embodiments, the invention can be used with several other types of devices, as well. For example, the invention can be employed as part of, or in conjunction or combination with cellular phones, personal digital assistants, global positioning devices (GPS), video camcorders, laptops, as well as other types of personal computers, and other devices having a built-in camera, as well as one or more touch-detecting surfaces.

It is specifically intended that the present invention not be limited to the embodiments and illustrations contained herein, but include modified forms of those embodiments, including portions of the embodiments and combinations of elements of different embodiments as come within the scope of the following claims.

We claim:

1. An image capture device, comprising,
at least one touch-detecting surface for detecting an applied first touch and an applied second touch, and
a processor in communication with the at least one touch detecting surfaces, the processor controlling the execution of an auto-focus operation in response to the first touch and the execution of an image capture operation in response to the second touch.

2. The image capture device of claim 1, wherein the at least one touch-detecting surfaces includes a touch screen.

3. The image capture device of claim 2, wherein the touch screen includes a first designated area for the first touch and a second non-overlapping designated area for the second touch.

4. The image capture device of claim 3, wherein the touch screen detects a single touch at a time.

5. The image capture device of claim 3, wherein the touch screen detects the first touch and the second touch when they overlap in time.

6. The image capture device of claim 2, wherein the touch screen includes a single designated area for the first touch and for the second touch.

7. The image capture device of claim 1, wherein the at least one touch-detecting surface includes a touch screen touch-detecting surface and a touch pad touch-detecting surface.

8. The image capture device of claim 7, wherein the first touch and the second touch are non-overlapping in time.

9. The image capture device of claim 7, wherein the first touch and the second touch are overlapping in time.

10. The image capture device of claim 7, wherein the first touch-detecting surface and the second touch detecting surface are on opposing sides of the camera.

11. The image capture device of claim 1, wherein the at least one touch-detecting surface includes a touch pad.

12. The image capture device of claim 11, wherein the touch pad includes a first designated area for the first touch and a second non-overlapping designated area for the second touch.

13. A method for using a touch-detecting surface in an image capture device, the method comprising,
detecting a first touch applied to a first touch-detecting surface,
executing an auto-focus operation in response to the detected first touch,
detecting a second touch applied to a second touch-detecting surface, and
executing an image capture operation in response to the detected second touch.

14. The method of claim 13, wherein the first touch and the second touch are non-overlapping in time.

15. The method of claim 13, wherein the first touch and the second touch overlap in time.

16. The method of claim 13, wherein the first touch-detecting surface and the second touch-detecting surface are the same touch-detecting surface.

17. The method of claim 16, wherein the first touch and the second touch are provided to the first-touch detecting surface.

18. The method of claim 13, wherein the first touch-detecting surface and the second touch-detecting surface are different touch-detecting surfaces.

19. An image capture device, comprising,
a touch screen for detecting an applied first touch and an applied second touch, for operation as a viewfinder, and for displaying a captured image, and
a processor in communication with the touch screen, the processor controlling the execution of an auto-focus operation in response to the first touch and the execution of an image capture operation in response to the second touch.

20. The image capture device of claim 19, wherein the touch screen includes a first designated area for the first touch and a second designated area for the second touch, and the touch screen detects multiple touches that overlap in time.
